(19) United States
(12) Patent Application Publication
(10) Pub. No.: US 2026/0034025 A1
(43) Pub. Date: Feb. 5, 2026

(54) APPARATUS, SYSTEM, AND METHOD FOR STORING MEDICAL, PHARMACEUTICAL, OR BIOLOGICAL MEDIA

(71) Applicant: SAINT-GOBAIN PERFORMANCE PLASTICS CORPORATION, Malvern, PA (US)

(72) Inventors: James David BOGHOSIAN, Natick, MA (US); Michael R. Huschke, Midland, MI (US); Matt Erle Leinberger, Saginaw, MI (US); Katie L. Campbell, Northborough, MA (US); Jonathon W. Wheatley, Traverse City, MI (US); Lei Zhang, Shrewsbury, MA (US); Michael F. Tuthill, Midland, MI (US)

(21) Appl. No.: 19/287,136

(22) Filed: Jul. 31, 2025

Related U.S. Application Data
(60) Provisional application No. 63/677,812, filed on Jul. 31, 2024.

(51) Int. Cl. A61J 1/00

(52) U.S. Cl. CPC A61J 1/00

(57) ABSTRACT

A apparatus including: a silicone-based body oriented down a central axis, the silicone-based body comprising: a rigid frame having a top axial surface and a bottom axial surface, an outer surface, and a substantially arcuate inner surface; and a plurality of gas-permeable, flexible film membranes connecting the inner surface about a perimeter of the rigid frame at the top axial surface and the bottom axial surface respectively to define an internal void within the body, wherein the rigid frame has a plurality of corrugations along the top axial surface and the bottom axial surface, and wherein the internal void provides for a medically, biologically, chemically, or pharmaceutically active environment.

### CROSS-REFERENCE TO RELATED APPLICATION(S)

This application claims priority under 35 U.S.C. § 119 (c) to U.S. Provisional Patent Application No. 63/677,812 entitled “APPARATUS, SYSTEM, AND METHOD FOR STORING MEDICAL, PHARMACEUTICAL, OR BIOLOGICAL MEDIA,” filed Jul. 31, 2024, by James David BOGHOSIAN et al., which is assigned to the current assignee hereof and is incorporated herein by reference in its entirety.

### FIELD OF THE DISCLOSURE

The present disclosure relates to apparatuses, systems, and methods for storing medical, pharmaceutical, or biological media.

### RELATED ART

Many pharmaceutical and bioprocessing processes utilize storage containers for storing fluid associated with medical, pharmaceutical, or biological media such as, but not limited to, cell cultures. Traditionally, the container can include a bag having at least one flexible portion-such as a flexible sidewall. In certain common instances, these containers can allow for more limited gas exchange to the media which restricts the efficiency of the desired modification or sustainment (e.g., cell growth/expansion potential) of the medical, pharmaceutical, or biological media within the container. Further, these containers may be unwieldly or cumbersome to handle, challenging to manufacture, and prone to less efficient storage. Therefore, the medical, pharmaceutical, and bioprocessing industries continue to demand better containers and associated technologies to permit more efficient storage, handling, and operation involving modification or sustainment of medical, pharmaceutical, and biological media.

### BRIEF DESCRIPTION OF THE DRAWINGS

Embodiments are illustrated by way of example and are not intended to be limited in the accompanying figures.

FIG. 1A includes a side perspective view of an apparatus in accordance with an embodiment.

FIG. 1B includes a side cross-sectional view of an apparatus in accordance with an embodiment.

FIG. 1C includes an end cross-sectional view of an apparatus in accordance with an embodiment.

FIG. 1D includes an end perspective cross-sectional view of an apparatus in accordance with an embodiment.

FIG. 1E includes an end cross-sectional view for an apparatus in accordance with an embodiment.

FIG. 1F includes a top cross-sectional view of an apparatus in accordance with an embodiment.

FIG. 1G includes a top perspective cross-sectional view of a frame for an apparatus in accordance with an embodiment.

FIG. 1H includes a top perspective cross-sectional view of a frame for an apparatus in accordance with an embodiment.

FIG. 1I includes a top perspective view of an access port frame portion for a frame for an apparatus in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the medical, pharmaceutical, and biological media processing and storage arts.

In accordance with one or more of the embodiments described herein, an apparatus may generally include: a silicone-based body oriented down a central axis, the silicone-based body including: a rigid frame having a top axial surface and a bottom axial surface, an outer surface, and a substantially arcuate inner surface; and a plurality of gas-permeable, flexible film membranes connecting the inner surface about a perimeter of the rigid frame at the top axial surface and the bottom axial surface respectively to define an internal void within the body, where the rigid frame has a plurality of corrugations along the top axial surface and the bottom axial surface, and where the internal void provides for a medically, biologically, chemically, or pharmaceutically active environment.

In accordance with one or more of the embodiments described herein, a system may generally include: a medium including a medical, biological, chemical, or pharmaceutical component; and an apparatus including: a silicone-based body oriented down a central axis, the silicone-based body including: a rigid frame having a top axial surface and a bottom axial surface, an outer surface, and a substantially arcuate inner surface; and a plurality of gas-permeable, flexible film membranes connecting the inner surface about a perimeter of the rigid frame at the top axial surface and the bottom axial surface respectively to define an internal void within the body, where the rigid frame has a plurality of corrugations along the top axial surface and the bottom axial surface, and where the internal void provides for a medically, biologically, chemically, or pharmaceutically active environment for the medium.

In accordance with one or more of the embodiments described herein, a method may generally include: providing a medium including a medical, pharmaceutical, or biological component; providing an apparatus including: a silicone-based body oriented down a central axis, the silicone-based body including: a rigid frame having a top axial surface and a bottom axial surface, an outer surface, and a substantially arcuate inner surface; and a plurality of gas-permeable, flexible film membranes connecting the inner surface about a perimeter of the rigid frame at the top axial surface and the bottom axial surface respectively to define an internal void within the body, where the rigid frame has a plurality of corrugations along the top axial surface and the bottom axial surface, and where the internal void provides for a medically, biologically, chemically, or pharmaceutically active environment; and disposing the medium within the medically, biologically, chemically, or pharmaceutically active environment within the internal void of the body.

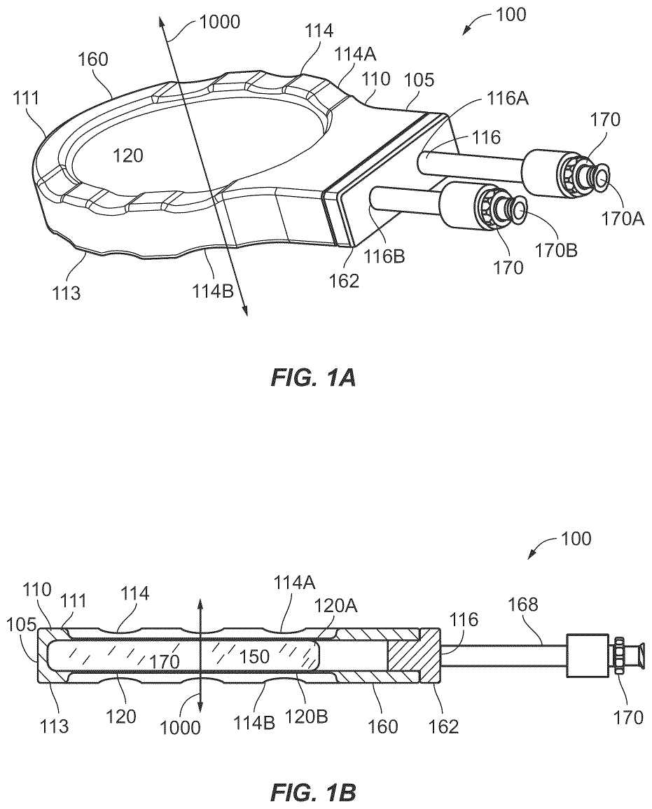

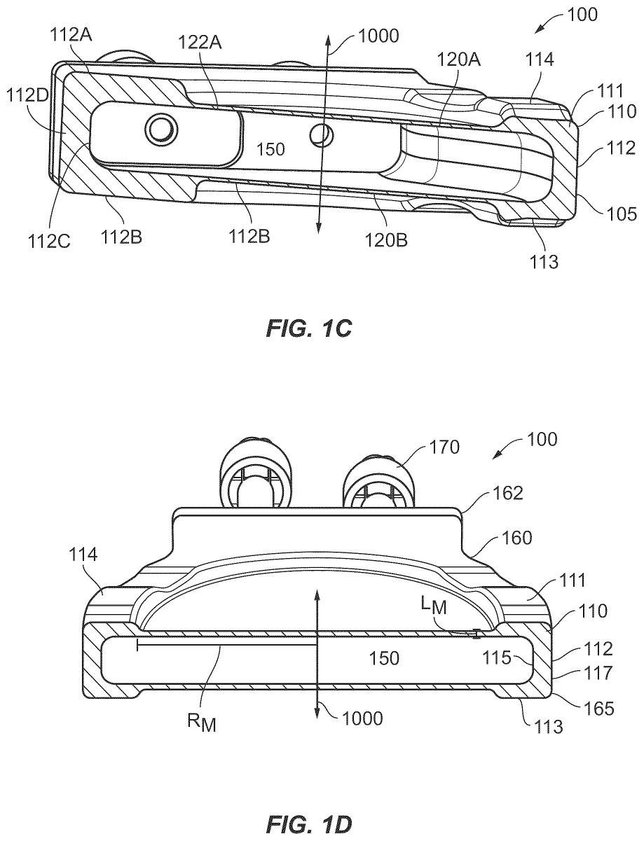

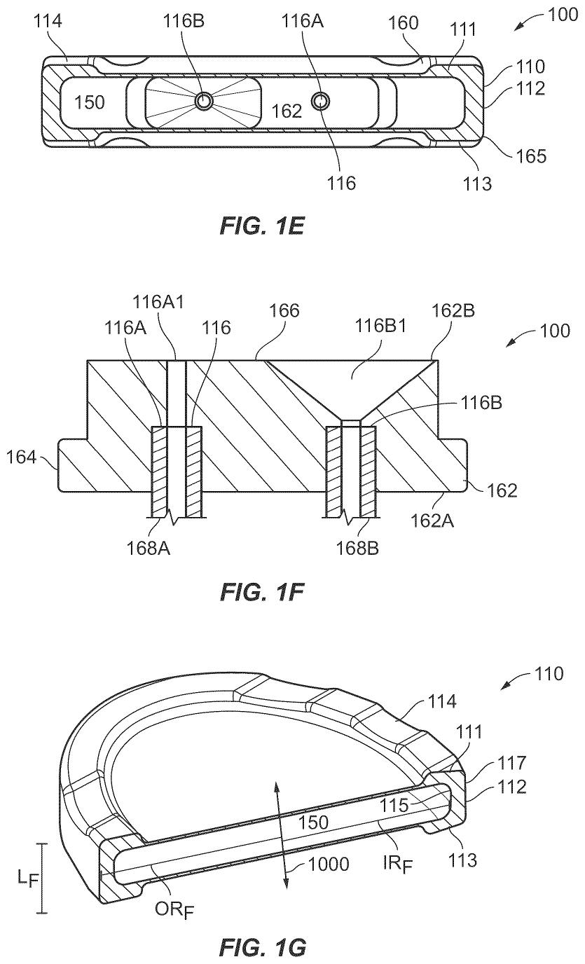

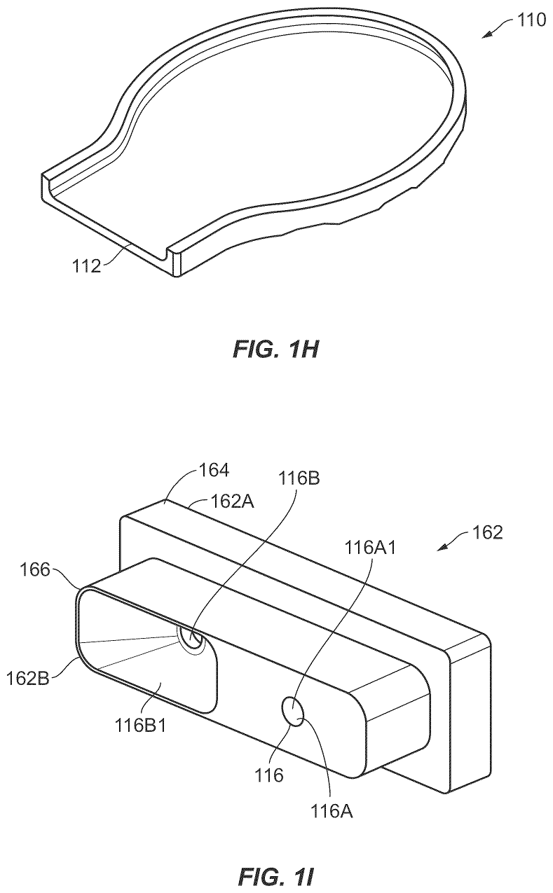

FIG. 1A includes a side perspective view of an apparatus 100 in accordance with an embodiment. FIG. 1B includes a side cross-sectional view of an apparatus 100 in accordance with an embodiment. FIG. 1C includes an end cross-sectional view of an apparatus in accordance with an embodiment. FIG. 1D includes an end perspective cross-sectional view of an apparatus accordance with an embodiment. FIG. 1E includes an end cross-sectional view for an apparatus in accordance with an embodiment. FIG. 1F includes a top cross-sectional view of an apparatus in accordance with an embodiment. FIG. 1G includes a top perspective cross-sectional view of a frame for an apparatus in accordance with an embodiment. FIG. 1H includes a top perspective cross-sectional view of a frame for an apparatus in accordance with an embodiment. It is contemplated that reference numerals are corresponding across all Figures disclosed herein. As shown in FIGS. 1A-1H, the apparatus 100 can generally include a body 105 oriented down a central axis 1000. The apparatus 100 or body 105 can include a frame 110. In a number of embodiments, the frame 110 may include an annular body 112. As used herein, the term “annular” may be defined as having a solid structure oriented 360° about the central axis 1000. The term “annular” including any cross-sectional shape (e.g., polygonal, oval, circular, semi-circular, or substantially circular cross-section) is contemplated herein. In particular embodiments, as shown in FIGS. 1A-1H, the body 105 of the frame 110 may form a substantially arcuate cross-sectional shape in a plane perpendicular to the central axis. In particular embodiments, the body 105 of the frame 110 may form a substantially rectilinear cross-sectional shape in a plane perpendicular to the central axis. In particular embodiments, the body 105 of the frame 110 may form a substantially elliptical cross-sectional shape in a plane perpendicular to the central axis, as shown. In particular embodiments, the body 105 of the frame 110 may form a substantially circular cross-sectional shape in a plane perpendicular to the central axis, as shown. In particular embodiments, the body 105 of the frame 110 may form a substantially polygonal cross-sectional shape in a plane perpendicular to the central axis, as shown. In particular embodiments, as shown in FIGS. 1A-1H, the body 105 of the frame 110 may form a substantially arcuate cross-sectional shape in a plane perpendicular to the central axis with a rectilinear side, resembling a tennis racket as shown best in FIG. 1H.

In a number of embodiments, the body 112 of the frame 110 may define an internal void 150 within an aperture 114 of the body 112 down the central axis 1000. In particular embodiments, as shown in FIGS. 1A-1H, the internal void 150 may form a substantially arcuate cross-sectional shape in a plane perpendicular to the central axis. In particular embodiments, as shown in FIGS. 1A-1H, the internal void 150 may form a substantially rectilinear cross-sectional shape in a plane perpendicular to the central axis. In particular embodiments, the internal void 150 may form a substantially elliptical cross-sectional shape in a plane perpendicular to the central axis, as shown. In particular embodiments, the internal void 150 may form a substantially circular cross-sectional shape in a plane perpendicular to the central axis, as shown. In particular embodiments, the internal void 150 may form a substantially polygonal cross-sectional shape in a plane perpendicular to the central axis, as shown. In particular embodiments, as shown in FIGS. 1A-1H, the internal void 150 may form a substantially arcuate cross-sectional shape in a plane perpendicular to the central axis with a rectilinear side, resembling a tennis racket as shown best in FIG. 1H. Further, as shown best in FIG. 1D, the body 112 of the frame 110 may define a top axial surface 111 and a bottom axial surface 113 down the central axis 1000. Further, as shown best in FIG. 1D, the body 112 of the frame 110 may define an inner surface 115 and an outer surface 117 down the central axis 1000.

Further, still referring to FIGS. 1A-1H, the apparatus 100 or body 105 can include at least one membrane 120 oriented down a central axis 1000. In a number of embodiments, as shown, the at least one membrane 120 may be adapted to couple to the top axial surface 111 or the bottom axial surface 113 of the body 112 of the frame 110 down the central axis 1000. In a number of embodiments, the at least one membrane 120 may include a body 122. As shown in FIGS. 1A-1H, the apparatus 100 can generally include a plurality of membranes 120A, 120B including a plurality of annular bodies 122, 122′. In a number of embodiments, the plurality of membranes 120A, 120B may be adapted to couple to the top axial surface 111 and the bottom axial surface 113 of the body 112 of the frame 110 down the central axis 1000 (one on each axial side respectively). Further, as shown best in FIGS. 1C-1D, the at least one membrane 120 may be adapted to couple to the top axial surface 111 or the bottom axial surface 113 of the body 112 of the frame 110 to fully form and enclose the internal void 150 around a perimeter of the apparatus 100 in at least one axial direction. Further, as shown in FIGS. 1A-1H the at least one membrane 120 may at least partially enclose the internal void 150 to provide for a medically, biologically, chemically, or pharmaceutically active environment within the internal void 150 of the frame 110 and subsequently the apparatus 100. Further, as shown in FIGS. 1A-1H, the plurality of membranes 130A, 130B may together at least partially enclose the internal void 150 completely in the axial direction down the central axis 1000 to provide for a medically, biologically, chemically, or pharmaceutically active environment within the internal void 150 of the frame 110 and subsequently the apparatus 100.

In a number of embodiments, as shown best in FIG. 1G, the frame 110 may have an outer radius ORF. For purposes of embodiments described herein, the frame 110 may have an outer radius ORF is the distance from the central axis 1000 to the outer surface 117. According to certain embodiments, frame 110 may have an outer radius ORF that may be at least about 10 mm, at least about 25 mm, at least about 50 mm, at least about 100 mm, at least about 150 mm, at least about 200 mm, at least about 250 mm, at least about 300 mm, or even at least about 500 mm. According to still other embodiments, frame 110 may have an outer radius ORF that may be not greater than about 1500 mm, not greater than about 1200 mm, or even not greater than about 1000 mm. It will be appreciated that the frame 110 may have an outer radius ORF that may be within a range between any of the minimum and maximum values noted above. It will be further appreciated that the frame 110 may have an outer radius ORF that may be any value between any of the minimum and maximum values noted above. It will be further appreciated that the frame 110 may have an outer radius ORF that coincides with the outer radius of the body 105 of the apparatus 100.

In a number of embodiments, as shown best in FIG. 1G, the frame 110 may have an inner radius IRF. For purposes of embodiments described herein, the frame 110 may have an inner radius IRF is the distance from the central axis 1000 to the inner surface 115. According to certain embodiments, frame 110 may have an inner radius IRF that may be at least about 10 mm, at least about 25 mm, at least about 50 mm, at least about 100 mm, at least about 150 mm, at least about 200 mm, at least about 250 mm, at least about 300 mm, or even at least about 500 mm. According to still other embodiments, frame 110 may have an inner radius IRF that may be not greater than about 1500 mm, not greater than about 1200 mm, or even not greater than about 1000 mm. It will be appreciated that the frame 110 may have an inner radius IRF that may be within a range between any of the minimum and maximum values noted above. It will be further appreciated that the frame 110 may have an inner radius IRF that may be any value between any of the minimum and maximum values noted above. It will be further appreciated that the frame 110 may have an inner radius IRF that coincides with the inner radius of the body 105 of the apparatus 100.

In a number of embodiments, as shown best in FIG. 1G, the frame 110 can have an axial length (or thickness) LF. For purposes of embodiments described herein, the length Le of the frame 110 is the distance from the top axial surface 111 to the bottom axial surface 113. According to certain embodiments, the length LF of the frame 110 may be at least about 5 mm, at least about 10 mm, at least about 25 mm, at least about 50 mm, at least about 100 mm, at least about 150 mm, at least about 200 mm, at least about 250 mm, at least about 300 mm, or even at least about 500 mm. According to still other embodiments, the length LF of the frame 110 may be not greater than about 1500 mm, not greater than about 1200 mm, or even not greater than about 1000 mm. It will be appreciated that the length LF of the frame 110 may be within a range between any of the minimum and maximum values noted above. It will be further appreciated that the length LF of the frame 110 may be any value between any of the minimum and maximum values noted above. It will be further appreciated that the frame 110 may have a length LF that coincides with the outer radius of the body 105 of the apparatus 100.

In a number of embodiments, as shown best in FIG. 1A-1H, the frame 110 may include at least one axially oriented coupling component 114. In a number of embodiments, the at least one axially oriented coupling component 114 of the frame 110 may couple to a neighboring apparatus 100. In a number of embodiments, as shown best in FIG. 1G, the frame 110 may include a plurality of axially oriented coupling components 114A, 114B. In a number of embodiments, the at least one axially oriented coupling component 114 may include at least one of nuts, bolts, bearings, battens, buckles, clips, flanges, frogs, grommets, hook-and-eyes, latches, pegs, nails, rivets, tongue and grooves, screw anchors, snap fasteners, stitches, threaded fasteners, ties, toggle bolts, wedges anchors, screws, bolts, clamps, clasps, clips, latches, pins, rivets, ties, nails, bores, welds, or combinations thereof. In particular embodiments, as shown in FIG. 1A-1H, the at least one axially oriented coupling component 114 may include a plurality of corrugations (i.e., apexes and nadirs) along at least one of its top or bottom axial surfaces 111, 113 around a perimeter of the frame 110. In a number of embodiments, the plurality of corrugations 114 may have an arcuate profile. In a number of embodiments, the plurality of corrugations 114 may have a rectilinear profile. In a number of embodiments, the plurality of corrugations 114 may be adapted to couple to the neighboring corrugations of a neighboring apparatus.

In a number of embodiments, as shown best in FIGS. 1A-1H, the frame 110 may include at least one access port 116 allowing for entrance or exit of a medium into or out of the apparatus 100. In a number of embodiments, as shown best in FIGS. 1A-1H, the frame 110 may include a plurality of access ports 116A, 116B allowing for entrance or exit of a medium into or out of the apparatus 100. In particular embodiments, as shown in FIGS. 1A-1H, the frame can include a cassette frame portion 160 and an access port frame portion 162. In particular embodiments, as shown in FIGS. 1A-1H, the frame portion 160 and the access port frame portion 162 may be separate pieces coupled together. In particular embodiments, the frame portion 160 and the access port frame portion 162 may be a single monolithic piece. As an example, FIG. 1I includes a top perspective view of an access port frame portion for a frame for an apparatus in accordance with an embodiment. As shown in FIG. 1I, the access port frame portion 162 can include the at least one access port 116 and often a plurality of access ports 116A, 116B. Further, in a number of embodiments, the access port frame portion 162 can include an axial flange 164 at a first end 162A and a radial flange 166 at a second end 162B. Further, the at least one access port 116 can include at least one port bore. For example, as shown best in FIG. 1F, the first access port 116A may include a narrow, cylindrical opening port bore 116A1 while the second access port 116B can contain a funneled opening port bore 116B1. In a number of embodiments, at least one of the cylindrical opening bore 116A1 or the funneled opening bore 116B1 may attach to fluid lines 168A, 168B which may include flexible tubing or another type of conduit. The fluid lines 168A, 168B may further include at least one coupling component 170. The coupling component 170 may pair to a neighboring device for transfer of a medium. All known coupling components listed herein are contemplated as part of the coupling component 170. In a number of specific embodiments, the coupling component 170 may include a barb, spike port, valve, tube, joint, connector, spigot, bag, or may be another type. In a number of embodiments, the at least one coupling component 170 can include a plurality of coupling components 170A, 170B.

In a number of embodiments, the at least one access port 116 may be adapted to permit, for example, sampling, transport, draining, or removal of medium from the apparatus 100. In a particular embodiment, at least one of the one or more access ports 116 can include at least one fluid port 11, at least two access ports 116, at least three access ports 116, at least four access ports 116, or at least five access ports 116. In another embodiment, the apparatus 100 can include no greater than twenty access ports 116, no greater than fifteen access ports 116, or no greater than ten access ports 116. In the illustrated embodiment, the access ports 116 may have a same shape and size. In other embodiments, the access ports 116 can have different shapes, sizes, lumen diameters, operational capacities, or any combination thereof relative to one another. In an embodiment, the one or more access ports 116 can be coupled with fluid lines 168A, 168B adapted to permit transport of medium from the apparatus 100 to an equipment or other medium destination. Resultantly, the body 105 may include at least one access port 116 disposed on a radial side of the body 105, where the at least one access port 116 allows for entrance or exit of a medium into or out of the apparatus 100. For example, the first access port 116A is for entrance of a medium into the apparatus 100 and a second access port 116B for exit of a medium out of the apparatus 100, each access port 116A, 116B coupled to the port bores 116A1, 116B1 of the access port frame portion 162.

In a number of embodiments, as shown in FIGS. 1A-1H, the at least one membrane 120 may include a body 122 forming an “annular shape” surrounding a bore or aperture defining an internal void 150 corresponding to the internal void of the apparatus 100 down a central axis 1000. In particular embodiments, the at least one membrane 120 may form a substantially hexagonal shape, as shown. The body 122 of the at least one membrane 120 may define a top axial surface 121 and a bottom axial surface 123 down the central axis 1000. Further, body 122 of the at least one membrane 120 may define an outer surface 127 down the central axis 1000 defining a major surface. In an embodiment, the at least one membrane 120 can include a medium or particulate for filtering. In another embodiment, the at least one membrane 120 can include a porous structure such as a block or structure of material having perforations or micro-perforations. In a further embodiment, the at least one membrane 120 can include a mesh, a screen, or a woven or non-woven medium. In yet another embodiment, the at least one membrane 120 can include a combination of filter elements. In a number of embodiments, the at least one membrane 120 may be a monolayer. In a number of embodiments, the at least one membrane 120 may be a multi-layer laminate.

In a number of embodiments, as shown best in FIG. 1D, the at least one membrane 120 may have a radius R_{M}. For purposes of embodiments described herein, the at least one membrane 120 may have a radius Ry is the distance from the central axis 1000 to the outer surface 127. According to certain embodiments, the at least one membrane 120 may have a radius Ry that may be at least about 10 mm, at least about 25 mm, at least about 50 mm, at least about 100 mm, at least about 150 mm, at least about 200 mm, at least about 250 mm, at least about 300 mm, or even at least about 500 mm. According to still other embodiments, the at least one membrane 120 may have a radius Ry that may be not greater than about 1500 mm, not greater than about 1200 mm, or even not greater than about 1000 mm. It will be appreciated that the at least one membrane 120 may have a radius Ry that may be within a range between any of the minimum and maximum values noted above. It will be further appreciated that the at least one membrane 120 may have a radius Ry that may be any value between any of the minimum and maximum values noted above.

In a number of embodiments, as shown best in FIG. 1D, the at least one membrane 120 can have an axial length (or thickness) Ly. For purposes of embodiments described herein, the length Ly of the at least one membrane 120 is the distance from the top axial surface 121 to the bottom axial surface 123. According to certain embodiments, the length Ly of the at least one membrane 120 may be at least about 0.01 mm, at least about 0.1 mm, at least about 1 mm, at least about 2 mm, at least about 5 mm, at least about 10 mm, at least about 25 mm, at least about 50 mm, at least about 100 mm, at least about 150 mm, at least about 200 mm, at least about 250 mm, at least about 300 mm, or even at least about 500 mm. According to still other embodiments, the length Ly of the at least one membrane 120 may be not greater than about 1500 mm, not greater than about 1200 mm, or even not greater than about 1000 mm. It will be appreciated that the length Ly of the at least one membrane 120 may be within a range between any of the minimum and maximum values noted above. It will be further appreciated that the length Ly of the at least one membrane 120 may be any value between any of the minimum and maximum values noted above.

Further, the ratio of the axial length (thickness) of the at least one of the flexible film membrane 120 to the axial length (thickness) of the frame 110 may be at least 0.1, at least 0.2, at least 0.3, at least 0.4, at least 0.5, at least 0.6, at least 0.7, at least 0.8, at least 0.9, at least 0.95, or even at least 0.99. The ratio of the thickness of the frame 110 to the thickness of the at least one of the flexible film membrane 120 may be no greater than 0.99, no greater than 0.95, no greater than 0.9, no greater than 0.8, no greater than 0.7, no greater than 0.6, no greater than 0.5, no greater than 0.4, no greater than 0.3, no greater than 0.2, or no greater than 0.1. It will be appreciated that ratio of the thickness of the frame 110 to the thickness of the at least one of the flexible film membrane 120 may be within a range between any of the minimum and maximum values noted above. It will be further appreciated that the ratio of the thickness of the frame 110 to the thickness of the at least one of the flexible film membrane 120 may be any value between any of the minimum and maximum values noted above. In a number of embodiments, the thickness of the frame 110 is greater than the thickness of the at least one of the flexible film membranes 120.

In a number of embodiments, the apparatus 100 or any components thereof listed herein (including, but not limited to, the frame 110 or the at least one membrane 120) can include a single-piece or monolithic body. In another embodiment, the apparatus 100 or any components thereof listed herein (including, but not limited to, the frame 110 or the at least one membrane 120) can include a multi-piece construction. In a number of embodiments, the apparatus 100 or any components thereof listed herein (including, but not limited to, the frame 110 or the at least one membrane 120) can include a single use apparatus. In another embodiment, the apparatus 100 or any components thereof listed herein (including, but not limited to, the frame 110 or the at least one membrane 120) can be reusable.

The apparatus 100 or any components thereof listed herein (including, but not limited to, the frame 110 or the at least one membrane 120) can be formed from any suitable material in the container arts. The apparatus 100 or any components thereof listed herein (including, but not limited to, the frame 110 or the at least one membrane 120) can be formed from a gas-permeable and liquid-impermeable material. The apparatus 100 or any components thereof listed herein (including, but not limited to, the frame 110 or the at least one membrane 120) can be formed from a rigid gas-permeable and liquid-impermeable material defined as having a Shore A hardness of at least 30 durometers. The apparatus 100 or any components thereof listed herein (including, but not limited to, the frame 110 or the at least one membrane 120) can be formed from a flexible gas-permeable and liquid-impermeable material.

In a particular embodiment, the apparatus 100 or any components thereof listed herein can at least partially include a polymer. The polymer may be a thermoplastic or thermosetting polymer. The polymer may be selected from the group including a polyketone, a polyaramid, a polyphenylene sulfide, a polyethersulfone, a polyphenylene sulfone, a polyamideimide, ultra high molecular weight polyethylene, a fluoropolymer, a polybenzimidazole, a polyacetal, polybutylene terephthalate (PBT), polypropylene (PP), rubber modified polypropylene, (EPDM/PP), polycarbonate (PC), Acrylonitrile butadiene styrene (ABS), polyethylene terephthalate (PET), a polyimide (PI), polyetherimide, polyetheretherketone (PEEK), polyetheretherketone (PAEK), polyethylene (PE), a polysulfone, a polyamide (PA), thermoplastic polyurethane (TPU), polyphenylene oxide, polyphenylene sulfide (PPS), a polyurethane, a polyester, a liquid crystal polymer (LCP), an elastomer, or any combination thereof. In an embodiment, the apparatus 100 or any components thereof listed herein may include, or even consist essentially of, a fluoropolymer. Exemplary fluoropolymers include a polytetrafluoroethylene (PTFE), a modified PTFE (TFM), a fluorinated ethylene propylene (FEP), a polyvinylidene fluoride (PVDF), a perfluoroalkoxy (PFA), a terpolymer of tetrafluoroethylene, a hexafluoropropylene and vinylidene fluoride (THV), a polychlorotrifluoroethylene (PCTFE), an ethylene tetrafluoroethylene copolymer (ETFE), an ethylene chlorotrifluoroethylene copolymer (ECTFE), EVA, silicone, polyolefin, polycarbonate, HDPE, POE, COC, COP, PMP, FEP, PTFE, FEP (fluorinated ethylene-propylene), TFE (tetrafluoroethylene), PFA (perfluoroalkoxy), PVF (polyvinylfluoride), PVDF (polyvinylidene fluoride), PTFE (polytetrafluoroethylene), PCTFE (polychlorotrifluoroethylene), ETFE (polyethylenetetrafluoroethylene), ECTFE (polyethylenechlorotrifluoroethylene), FFPM/FFKM (perfluoroelastomer), FPM/FKM (chlorotrifluoroethylenevinylidene fluoride), PFPE (perfluoropolyether), MFA (tetrafluoroethylene and perfluoromethyl vinyl-ether copolymer), CTFE/VDF (chlorotrifluoroethylene-vinylidene fluoride copolymer), and TFE/HFP (tetrafluoroethylene-hexafluoropropylene copolymer), natural polyisoprene rubber (NR), synthetic polyisoprene rubber (IR), polybutadiene rubber (BR), chloroprene rubber (CR), butyl rubber (IIR), halogenated butyl rubbers (CIIR, BIIR), styrene-butadiene rubber (SBR), nitrile rubber (NBR) and hydrogenated nitrile rubber (HNBR), ethylene propylene rubber (EPM), ethylene propylene diene rubber (EPDM), epichlorohydrin rubber (ECO), polyacrylic rubber (ACM, ABR), silicone rubber (SI, Q, VMQ), fluorosilicone rubber (FSR, FVMQ), fluoroelastomers (FKM, FEPM), perfluoroelastomers (FFKM), polyether block amides (PEBA), chlorosulfonated polyethylene (CSM), ethylene-vinyl acetate (EVA), cyclic olefin copolymers, polyolefin elastomers, polypropylene elastomer (PE), elastomeric PET, or mixtures thereof, or any combination thereof. Other fluoropolymers, polymers, and blends may be included in the composition of the apparatus 100 or any components thereof listed herein. In another particular embodiment, the apparatus 100 or any components thereof listed herein can at least partially include, or even consist essentially of, a polyethylene (PE) such as an ultra-high-molecular-weight polyethylene (UHMWPE). In another particular embodiment, the apparatus 100 or any components thereof listed herein may include a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, an olefin-based ter-polymer, a polyolefin plastomer, or combinations thereof. In an embodiment, the apparatus 100 or any components thereof listed herein may include a styrene based block copolymer such as styrene-butadiene, styrene-isoprene, blends or mixtures thereof, and the like. Exemplary styrenic thermoplastic elastomers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. Commercial examples include some grades of Kraton™ and Hybrar™ resins. In an embodiment, the apparatus 100 or any components thereof listed herein may include an elastomer including at least one of Acrylonitrile-Butadiene (NBR) Carboxylated Nitrile (XNBR) Ethylene Acrylate (AEM, Vamac®), Ethylene Propylene Rubber (EPR, EPDM), Butyl Rubber (IIR), Chloroprene Rubber (CR), Fluorocarbon (FKM, FPM), Fluorosilicone (FVMQ), Hydrogenated Nitrile (HNBR), Perfluoroelastomer (FFKM), Polyacrylate (ACM), Polyurethane (AU, EU), Silicone Rubber (Q, MQ, VMQ, PVMQ), Tetrafluoroethylene-Propylene (AFLAS®) (FEPM). In a number of embodiments, the apparatus 100 or any components thereof listed herein may be formed from any conventional methods known for polymer manufacturing, such as injection molding, billeting, cutting/slicing, hot or cold pressing, direct forming, extrusion, skiving, machining, or CNC machining.

In an embodiment, the apparatus 100 or any components thereof listed herein (including, but not limited to, the frame 110 or the at least one membrane 120) can at least partially include a rigid material such as, but not limited to, a metal. According to certain embodiments, the metal may include iron, copper, titanium, tin, aluminum, alloys thereof, or may be another type of metal. In an embodiment, the apparatus 100 or any components thereof listed herein can include a metal (such as aluminum, zinc, copper, magnesium, tin, platinum, titanium, tungsten, iron, bronze, steel, energizer steel, stainless steel), a metal alloy (including the metals listed), an anodized metal (including the metals listed), or any combination thereof. In a number of embodiments, the apparatus 100 or any components thereof listed herein may be formed from any conventional methods known for metalworking, such as chamfering, turning, reaming, forging, extruding, molding, micromolding, micromachining, sintering, rolling, or casting, injection molding, metalworking, flattening, or 3-D printing (including binderjetting, stereolithography, filament disposition method, laser melting, laser sintering, electron beam melting).

In an embodiment, the apparatus 100 or any components thereof listed herein (including, but not limited to, the frame 110 or the at least one membrane 120) can include a ceramic such as alumina, silica, titanium dioxide, calcium fluoride, boron nitride, mica, wollastonite, glass fibers, silicon carbide, silicon nitride, zirconia, carbon black, pigments, or any combination thereof. In a number of embodiments, the apparatus 100 or any components thereof listed herein may be formed from any conventional methods known for ceramic manufacturing, such as chamfering, turning, reaming, forging, extruding, molding, micromolding, micromachining, sintering, rolling, or casting, injection molding, metalworking, flattening, or 3-D printing (including binderjetting, stereolithography, filament disposition method, laser melting, laser sintering, electron beam melting).

In an embodiment, the apparatus 100 or any components thereof listed herein (including, but not limited to, the frame 110 or the at least one membrane 120) can be treated, impregnated, filled, or coated with a lubricious material or filler as a coating or surface treatment. Exemplary lubricious materials or fillers include molybdenum disulfide, tungsten disulfide, graphite, grapheme, expanded graphite, boron nitride, talc, calcium fluoride, or any combination thereof. Additionally, the lubricious material or filler can include a ceramic such as alumina, silica, titanium dioxide, calcium fluoride, boron nitride, mica, wollastonite, glass fibers, silicon carbide, silicon nitride, zirconia, carbon black, pigments, or any combination thereof. In an embodiment, the apparatus 100 or any components thereof listed herein (including, but not limited to, the frame 110 or the at least one membrane 120) may be a material that is resistant to oxygen, hydrogen, hydroxide, or temperature resistant. In a number of embodiments, the apparatus 100 or any components thereof listed herein may be monolithic. In alternative embodiments, the apparatus 100 or any components thereof listed herein (including, but not limited to, the frame 110 or the at least one membrane 120) may not be monolithic and may include multiple pieces as described above.

In a number of embodiments, the apparatus 100 or any components thereof listed herein (including, but not limited to, the frame 110 or the at least one membrane 120) may include silicone. In a number of embodiments, the apparatus 100 or any components thereof listed herein (including, but not limited to, the frame 110 or the at least one membrane 120) may include at least 50 wt. % silicone, such as at least 75 wt. % silicone, such as at least 80 wt. % silicone, such as at least 85 wt. % silicone, such as at least 90 wt. % silicone, such as at least 95 wt. % silicone, such as at least 97 wt. % silicone, such as at least 99 wt. % silicone, or such as at least 99.9 wt. % silicone. As defined herein the apparatus 100 or any components thereof listed herein (including, but not limited to, the frame 110 or the at least one membrane 120) can be a silicone-based component defined as including a composition that is at least 75 wt. % silicone.

In an embodiment, the apparatus 100 or any components thereof listed herein (including, but not limited to, the frame 110 or the at least one membrane 120) can advantageously withstand sterilization processes. In an embodiment, the apparatus 100 or any components thereof listed herein may be sterilized by any method envisioned. For instance, the polymer of the apparatus 100 is sterilized after the apparatus 100 is formed. Exemplary sterilization methods include radiation (such as X-ray radiation), electron ray, E-beam or electron beam sterilization techniques, combinations thereof, and the like. In a particular embodiment, the polymer or polymeric blend is sterilized by vaporized hydrogen peroxide sterilization (VHP). In a particular embodiment, the apparatus 100 or any components thereof listed herein is sterilized by gamma irradiation. For instance, the apparatus 100 or any components thereof listed herein may be gamma sterilized at between about 25 kGy to about 50 kGy.

In embodiment, the apparatus 100 or any components thereof listed herein (including, but not limited to, the frame 110 or the at least one membrane 120) may have further desirable physical and mechanical properties. For instance, the apparatus 100 or any components thereof listed herein may appear transparent or at least translucent. For instance, the apparatus 100 or any components thereof listed herein may have a light transmission greater than about 2%, or greater than about 5% in the visible light wavelength range. In particular, the resulting articles have desirable clarity or translucency. In addition, the apparatus 100 or any components thereof listed herein may have advantageous physical properties, such as a balance of any one or more of the properties of hardness, flexibility, surface lubricity, tensile strength, elongation, Shore A hardness, gamma resistance, weld strength, and container integrity to an optimum level.

In an embodiment, the apparatus 100 or any components thereof listed herein (including, but not limited to, the frame 110 or the at least one membrane 120) may have desirable heat stability properties. Applications for the polymer or polymeric blend are numerous. In particular, the apparatus 100 or any components thereof listed herein may be non-toxic, making the material useful for any application where no toxicity is desired. For example, the apparatus 100 or any components thereof listed herein may be substantially free of plasticizers or other low-molecular weight extenders that can be leached into the fluids it transfers. “Substantially free” as used herein refers to a polymeric mixture having a total organic content (TOC) (measured in accordance to ISO 15705 and EPA 410.4) of less than about 100 ppm. Further, the apparatus 100 or any components thereof listed herein may have biocompatibility and animal derived component-free formulation ingredients. For instance, the apparatus 100 or any components thereof listed herein may have potential for FDA, USP, EP, ISO, and other regulatory approvals. In an exemplary embodiment, the apparatus 100 or any components thereof listed herein may be used in applications such as industrial, medical, health care, biopharmaceutical, pharmaceutical, drinking water, food & beverage, laboratory, dairy, and the like. In an embodiment, the apparatus 100 or any components thereof listed herein may be used in applications where low temperature resistance is desired. In an embodiment, the apparatus 100 or any components thereof listed herein may also be safely disposed as it generates substantially no toxic gases when incinerated and leaches no plasticizers into the environment if land filled.

In some embodiments, as shown best in FIG. 1B, the apparatus 100 may be configured to contain and modify and/or sustain a product 170 within its internal void 150 to form a system. The product 170 may include medium containing a medical, biological, chemical, or pharmaceutical component. In a number of embodiments, the medical, biological, chemical or pharmaceutical component may be at least one of a cell, biofluid, virus, microphage, protein, antibody, pharmaceutical, therapeutic, buffer, or combinations thereof. In a number of embodiments, the product 170 may include a fluid for use in medical, biological, chemical, or pharmaceutical applications. In a number of embodiments, the product 170 may include a fluid for use in medical, biological, chemical, or pharmaceutical applications. In a number of embodiments, the product 170 may include a biomedia fluid for use in medical, biological, chemical, or pharmaceutical applications such as, but not limited to, cell cultures. In a number of embodiments, the product 170 may include a biomedia fluid for use in medical, biological, or chemical, pharmaceutical applications such as, but not limited to, cell cultures. In a number of embodiments, the medically, biologically, chemically, or pharmaceutically active environment within the apparatus 100 according to embodiments herein may be adapted to undergo a biological process or chemical reaction to modify or sustain the medical, biological, chemical, or pharmaceutical component 170 within the medium as provided by the medically, biologically, chemically, or pharmaceutically active environment within the internal void 150 of the apparatus 100.

In accordance with embodiments described herein, a method of making a system for storing medical, biological, chemical, or pharmaceutical media is shown. The method can include providing a medium including a medical, pharmaceutical, or biological component 170. The method may further include providing an apparatus 100 including a silicone-based body 105 oriented down a central axis 1000, the silicone-based body 105 including: a rigid frame 110 having a top axial surface 111 and a bottom axial surface 113, an outer surface 117, and a substantially arcuate inner surface 115; and a plurality of gas-permeable, flexible film membranes 120 connecting the inner surface 115 about a perimeter of the rigid frame 110 at the top axial surface 111 and the bottom axial surface 113 respectively to define an internal void 150 within the body 105, where the rigid frame 110 has a plurality of corrugations 114 along the top axial surface 111 and the bottom axial surface 113, and where the internal void 150 provides for a medically, biologically, chemically, or pharmaceutically active environment. The method may further include disposing the medium within the medically, biologically, chemically, or pharmaceutically active environment within the internal void 150 of the body 105 of the frame 110 and subsequent apparatus 100.

In a particular instance, apparatuses, systems and methods described herein can be adapted for use with medical, biological, chemical, or pharmaceutical media. In an embodiment, the apparatuses, systems and methods described herein can be used to allow for more efficient handling, storage, better gas diffusion, and better operation involving modification or sustainment of the media within the apparatus unlike previous or conventional apparatuses of similar use. This may lengthen the lifetime and efficiency of the apparatus and the medical, biological, chemical, or pharmaceutical media cultivated therein.

### EXAMPLES

In a number of embodiments, the apparatus may provide a gas exchange factor of 40,000 cc/m²-day-atm at room temperature and 37° C. (with CO₂ gas as a non-limiting gas example). This is an improvement over previous or conventional apparatuses of similar use.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Embodiment 1: An apparatus comprising: a silicone-based body oriented down a central axis, the silicone-based body comprising: a rigid frame having a top axial surface and a bottom axial surface, an outer surface, and a substantially arcuate inner surface; and a plurality of gas-permeable, flexible film membranes connecting the inner surface about a perimeter of the rigid frame at the top axial surface and the bottom axial surface respectively to define an internal void within the body, wherein the rigid frame has a plurality of corrugations along the top axial surface and the bottom axial surface, and wherein the internal void provides for a medically, biologically, chemically, or pharmaceutically active environment.

Embodiment 2: A system comprising: a medium comprising a medical, biological, chemical, or pharmaceutical component; and an apparatus comprising: a silicone-based body oriented down a central axis, the silicone-based body comprising: a rigid frame having a top axial surface and a bottom axial surface, an outer surface, and a substantially arcuate inner surface; and a plurality of gas-permeable, flexible film membranes connecting the inner surface about a perimeter of the rigid frame at the top axial surface and the bottom axial surface respectively to define an internal void within the body, wherein the rigid frame has a plurality of corrugations along the top axial surface and the bottom axial surface, and wherein the internal void provides for a medically, biologically, chemically, or pharmaceutically active environment for the medium.

Embodiment 3: A method comprising: providing a medium comprising a medical, pharmaceutical, or biological component; providing an apparatus comprising: a silicone-based body oriented down a central axis, the silicone-based body comprising: a rigid frame having a top axial surface and a bottom axial surface, an outer surface, and a substantially arcuate inner surface; and a plurality of gas-permeable, flexible film membranes connecting the inner surface about a perimeter of the rigid frame at the top axial surface and the bottom axial surface respectively to define an internal void within the body, wherein the rigid frame has a plurality of corrugations along the top axial surface and the bottom axial surface, and wherein the internal void provides for a medically, biologically, chemically, or pharmaceutically active environment; and disposing the medium within the medically, biologically, chemically, or pharmaceutically active environment within the internal void of the body.

Embodiment 4: The apparatus, system, or method of any of the preceding embodiments, wherein the silicone-based body further comprises a gas-permeable and liquid-impermeable material.

Embodiment 5: The apparatus, system, or method of embodiment 4, wherein the gas-permeable and liquid-impermeable material comprises at least 99 wt. % silicone.

Embodiment 6: The apparatus, system, or method of embodiment 4, wherein the gas-permeable and liquid-impermeable material further comprises at least one of a natural polyisoprene rubber (NR), synthetic polyisoprene rubber (IR), polybutadiene rubber (BR), chloroprene rubber (CR), butyl rubber (IIR), halogenated butyl rubbers (CIIR, BIIR), styrene-butadiene rubber (SBR), nitrile rubber (NBR) and hydrogenated nitrile rubber (HNBR), ethylene propylene rubber (EPM), ethylene propylene diene rubber (EPDM), epichlorohydrin rubber (ECO), polyacrylic rubber (ACM, ABR), silicone rubber (SI, Q, VMQ), fluorosilicone rubber (FSR, FVMQ), fluoroelastomers (FKM, FEPM), perfluoroelastomers (FFKM), polyether block amides (PEBA), chlorosulfonated polyethylene (CSM), ethylene-vinyl acetate (EVA), cyclic olefin copolymers, polyolefin elastomers, polypropylene elastomer (PE), elastomeric PET, or a combination thereof.

Embodiment 7: The apparatus, system, or method of any of the preceding embodiments, wherein at least one of the flexible film membranes comprises a monolayer.

Embodiment 8: The apparatus, system, or method of any of the preceding embodiments wherein at least one of the flexible film membranes comprises a multilayer laminate.

Embodiment 9: The apparatus, system, or method of any of the preceding embodiments, wherein at least one of the flexible film membranes has a thickness of at least 0.2 mm.

Embodiment 10: The apparatus, system, or method of any of the preceding embodiments, wherein the frame has a thickness of at least 0.2 mm.

Embodiment 11: The apparatus, system, or method of any of the preceding embodiments, wherein the thickness of the frame is greater than the thickness of the at least one of the flexible film membranes.

Embodiment 12: The apparatus, system, or method of any of the preceding embodiments, wherein the body has a substantially elliptical cross-section in a plane perpendicular to the central axis.

Embodiment 13: The apparatus, system, or method of any of the preceding embodiments, wherein the frame has a substantially elliptical cross-section in a plane perpendicular to the central axis.

Embodiment 14: The apparatus, system, or method of any of the preceding embodiments, wherein the body has a substantially circular cross-section in a plane perpendicular to the central axis.

Embodiment 15: The apparatus, system, or method of any of the preceding embodiments, wherein the frame has a substantially circular cross-section in a plane perpendicular to the central axis.

Embodiment 16: The apparatus, system, or method of any of the preceding embodiments, wherein the body has a substantially polygonal cross-section in a plane perpendicular to the central axis.

Embodiment 17: The apparatus, system, or method of any of the preceding embodiments, wherein the frame has a polygonal cross-section in a plane perpendicular to the central axis.

Embodiment 18: The apparatus, system, or method of any of the preceding embodiments, wherein at least one of the plurality of corrugations has an arcuate profile.

Embodiment 19: The apparatus, system, or method of any of the preceding embodiments, wherein the corrugations are adapted to couple to the neighboring corrugations of a neighboring apparatus.

Embodiment 20: The apparatus, system, or method of any of the preceding embodiments, wherein the frame is monolithic.

Embodiment 21: The apparatus, system, or method of any of the preceding embodiments, wherein the frame comprises a cassette frame portion and an access port frame portion.

Embodiment 22: The apparatus, system, or method of embodiment 21, wherein the access port frame portion comprises a plurality of port bores.

Embodiment 23: The apparatus, system, or method of any of the preceding embodiments, wherein the body comprises at least one access port disposed on a radial side of the body, wherein the at least one access port allows for entrance or exit of a medium into or out of the apparatus.

Embodiment 24: The apparatus, system, or method of embodiment 23, wherein the at least one access port comprises a first access port for entrance of a medium into the apparatus and a second access port for exit of a medium out of the apparatus, each access port coupled to the port bores of the access port frame portion.

Embodiment 25: The apparatus, system, or method of embodiment 23, wherein the at least one access port comprises a flexible tubing comprising a coupling component.

Embodiment 26: The apparatus, system, or method of embodiment 25, wherein the coupling component comprises at least one of a barb or spigot.

Embodiment 27: The apparatus, system, or method of any of the preceding embodiments, wherein the internal void has a substantially arcuate profile.

Embodiment 28: The apparatus, system, or method of any of the preceding embodiments, wherein the internal void has an elliptical cross-section in a plane perpendicular to the central axis.

Embodiment 29: The apparatus, system, or method of any of the preceding embodiments, wherein the internal void has a circular cross-section in a plane perpendicular to the central axis.

Embodiment 30: The apparatus, system, or method of any of the preceding embodiments, wherein the internal void has a polygonal cross-section in a plane perpendicular to the central axis.

Embodiment 31: The apparatus, system, or method of any of the preceding embodiments, wherein the body has an axial length of between 5 and 1500 mm.

Embodiment 32: The apparatus, system, or method of any of the preceding embodiments, wherein the body has an inner radius of between 10 and 1500 mm.

Embodiment 33: The apparatus, system, or method of any of the preceding embodiments, wherein the body has an outer radius of between 10 and 1500 mm.

Embodiment 34: The apparatus, system, or method of any of the preceding embodiments, wherein the apparatus provides a gas exchange factor of 40,000 cc/m²-day-atm at room temperature and 37° C.

Embodiment 35: The apparatus, system, or method of any of the preceding embodiments, wherein the medically, biologically, chemically, or pharmaceutically active environment allows for a biological process to take place to modify or sustain the medium.

Embodiment 36: The apparatus, system, or method of any of the preceding embodiments, wherein the medical, pharmaceutical, or biological component comprises at least one of a cell, biofluid, virus, microphage, protein, antibody, pharmaceutical, therapeutic, buffer, or combinations thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An apparatus comprising:
a silicone-based body oriented down a central axis, the silicone-based body comprising:
a rigid frame having a top axial surface and a bottom axial surface, an outer surface, and a substantially arcuate inner surface; and
a plurality of gas-permeable, flexible film membranes connecting the inner surface about a perimeter of the rigid frame at the top axial surface and the bottom axial surface respectively to define an internal void within the body, wherein the rigid frame has a plurality of corrugations along the top axial surface and the bottom axial surface, and wherein the internal void provides for a medically, biologically, chemically, or pharmaceutically active environment.

2. A system comprising:
a medium comprising a medical, biological, chemical, or pharmaceutical component; and
an apparatus comprising:
a silicone-based body oriented down a central axis, the silicone-based body comprising:
a rigid frame having a top axial surface and a bottom axial surface, an outer surface, and a substantially arcuate inner surface; and
a plurality of gas-permeable, flexible film membranes connecting the inner surface about a perimeter of the rigid frame at the top axial surface and the bottom axial surface respectively to define an internal void within the body, wherein the rigid frame has a plurality of corrugations along the top axial surface and the bottom axial surface, and wherein the internal void provides for a medically, biologically, chemically, or pharmaceutically active environment for the medium.

3. A method comprising:
providing a medium comprising a medical, pharmaceutical, or biological component;
providing an apparatus comprising:
a silicone-based body oriented down a central axis, the silicone-based body comprising:
a rigid frame having a top axial surface and a bottom axial surface, an outer surface, and a substantially arcuate inner surface; and
a plurality of gas-permeable, flexible film membranes connecting the inner surface about a perimeter of the rigid frame at the top axial surface and the bottom axial surface respectively to define an internal void within the body, wherein the rigid frame has a plurality of corrugations along the top axial surface and the bottom axial surface, and wherein the internal void provides for a medically, biologically, chemically, or pharmaceutically active environment; and
disposing the medium within the medically, biologically, or pharmaceutically active environment within the internal void of the body.

4. The apparatus of claim 1, wherein the silicone-based body further comprises a gas-permeable and liquid-impermeable material.

5. The apparatus of claim 4, wherein the gas-permeable and liquid-impermeable material comprises at least 99 wt. % silicone.

6. The apparatus of claim 4, wherein the gas-permeable and liquid-impermeable material further comprises at least one of a natural polyisoprene rubber (NR), synthetic polyisoprene rubber (IR), polybutadiene rubber (BR), chloroprene rubber (CR), butyl rubber (IIR), halogenated butyl rubbers (CIIR, BIIR), styrene-butadiene rubber (SBR), nitrile rubber (NBR) and hydrogenated nitrile rubber (HNBR), ethylene propylene rubber (EPM), ethylene propylene diene rubber (EPDM), epichlorohydrin rubber (ECO), polyacrylic rubber (ACM, ABR), silicone rubber (SI, Q, VMQ), fluorosilicone rubber (FSR, FVMQ), fluoroelastomers (FKM, FEPM), perfluoroelastomers (FFKM), polyether block amides (PEBA), chlorosulfonated polyethylene (CSM), ethylene-vinyl acetate (EVA), cyclic olefin copolymers, polyolefin elastomers, polypropylene elastomer (PE), elastomeric PET, or a combination thereof.

7. The apparatus of claim 1, wherein at least one of the flexible film membranes comprises a monolayer.

8. The apparatus of claim 1, wherein at least one of the flexible film membranes comprises a multilayer laminate.

9. The apparatus of claim 1, wherein the thickness of the frame is greater than the thickness of the at least one of the flexible film membranes.

10. The apparatus of claim 1, wherein at least one of the plurality of corrugations has an arcuate profile.

11. The apparatus of claim 1, wherein the corrugations are adapted to couple to the neighboring corrugations of a neighboring apparatus.

12. The apparatus of claim 1, wherein the frame comprises a cassette frame portion and an access port frame portion.

13. The apparatus of claim 1, wherein the body comprises at least one access port disposed on a radial side of the body, wherein the at least one access port allows for entrance or exit of a medium into or out of the apparatus.

14. The apparatus of claim 13, wherein the at least one access port comprises a flexible tubing comprising a coupling component.

15. The apparatus of claim 14, wherein the coupling component comprises at least one of a barb or spigot.

16. The apparatus of claim 1, wherein the internal void has a substantially arcuate profile.

17. The apparatus of claim 1, wherein the internal void has an elliptical cross-section in a plane perpendicular to the central axis.

18. The apparatus of claim 1, wherein the internal void has a circular cross-section in a plane perpendicular to the central axis.

19. The apparatus of claim 1, wherein the internal void has a polygonal cross-section in a plane perpendicular to the central axis.

20. The apparatus of claim 1, wherein the apparatus provides a gas exchange factor of 40,000 cc/m²-day-atm at room temperature and 37° C.
